(19) United States
(12) Patent Application Publication
(10) Pub. No.: US 2025/0343605 A1
(43) Pub. Date: Nov. 6, 2025

(54) CONFINEMENT ASSEMBLY WITH INTEGRATED 3D OPTICAL PATHS FOR QUANTUM OBJECT INTERACTION

(71) Applicant: Quantinuum LLC, Broomfield, CO (US)

(72) Inventors: Mary A. ROWE, Boulder, CO (US); Rezlind BUSHATI, Broomfield, CO (US); Johanna ZULTAK, Broomfield, CO (US); Molly R. KROGSTAD, Westminster, CO (US); Sara CAMPBELL, Boulder, CO (US); Adam JAY OLLANIK, Boulder, CO (US)

(21) Appl. No.: 19/169,403

(22) Filed: Apr. 3, 2025

Related U.S. Application Data
(60) Provisional application No. 63/642,261, filed on May 3, 2024.

(51) Int. Cl. H04B 10/70; G06N 10/40

(52) U.S. Cl. CPC H04B 10/70; G06N 10/40

(57) ABSTRACT

A signal management system is configured to provide photonic signals to a plurality of target positions defined at least in part by a confinement apparatus configured to confine a plurality of quantum objects. The signal management system includes a plurality of waveguides; and a plurality of signal manipulation elements comprising (a) a first set of signal manipulation elements of a first type and (b) a second set of signal manipulation elements of a second type. A second signal manipulation element of the second set of signal manipulation elements is optically coupled to a waveguide of the plurality of waveguides via a first signal manipulation element of the first set of signal manipulation elements. The signal management system may be part of a confinement assembly including the confinement apparatus.

### CROSS-REFERENCE TO RELATED APPLICATION(S)

This application claims priority to U.S. Application No. 63/642,261, filed May 3, 2024, the content of which is incorporated herein by reference in its entirety.

### TECHNICAL FIELD

Various embodiments relate to confinement assemblies that include confinement apparatuses for confining quantum and/or atomic objects and integrated optical paths for providing photonic signals for interacting with the quantum and/or atomic objects and systems that include such confinement assemblies. An example embodiment relates to a confinement assembly that uses multiple types of signal manipulation elements to define the integrated optical paths.

### BACKGROUND

Quantum and/or atomic object confinement apparatuses are used to confine or trap atomic objects, such as atoms, ions, molecules, and/or the like. In various scenarios, it may be desired to confine a large number (e.g., thousands) of quantum and/or atomic objects within a confinement apparatus such that the quantum and/or atomic objects may be interacted with via photonic signals, for example. It appears that conventional beam delivery systems are not capable of providing optical beams for interacting with a large number of quantum and/or atomic objects within a confinement apparatus while also meeting various other design requirements of such systems. Through applied effort, ingenuity, and innovation many deficiencies of such systems including confinement apparatuses have been solved by developing solutions that are structured in accordance with the embodiments of the present invention, many examples of which are described in detail herein.

### BRIEF SUMMARY OF EXAMPLE EMBODIMENTS

Example embodiments provide confinement assemblies that include confinement apparatuses for confining quantum and/or atomic objects and a signal management system defining integrated optical paths for providing photonic signals for interacting with the quantum and/or atomic objects and systems that include such confinement assemblies. In various embodiments, the optical paths are defined at least in part by respective waveguides and respective signal manipulation elements. In various embodiments, an optical path includes signal manipulation elements of at least two different types. For example, an optical path may be defined, at least in part, by a first signal manipulation element of a first type, such as a grating coupler, configured to couple the photonic signal out of a respective waveguide. The optical path may be further defined by a second signal manipulation element of a second type, such as a metasurface, configured to control various optical properties of the photonic signal. For example, the second signal manipulation element may change the direction of propagation of the photonic signal such that the photonic signal is incident at a target location that is defined, at least in part, by the confinement apparatus.

According to an example embodiment, signal management system is provided. In an example embodiment, the signal management system is configured to provide photonic signals to a plurality of target positions defined at least in part by a confinement apparatus configured to confine a plurality of quantum objects. In an example embodiment, the signal management system includes a plurality of waveguides; and a plurality of signal manipulation elements comprising (a) a first set of signal manipulation elements of a first type and (b) a second set of signal manipulation elements of a second type. A second signal manipulation element of the second set of signal manipulation elements is optically coupled to (e.g., placed into optical communication with) a waveguide of the plurality of waveguides via a first signal manipulation element of the first set of signal manipulation elements.

In an example embodiment, the signal manipulation elements of the first type are configured to couple respective photonic signals out of respective waveguides of the plurality of waveguides.

In an example embodiment, the signal manipulation elements of the second type are configured to redirect the respective photonic signals to respective target positions of the plurality of target positions.

In an example embodiment, the signal manipulation elements of the first type are grating couplers.

In an example embodiment, the signal manipulation elements of the second type are metasurfaces.

In an example embodiment, an optical path defined by a waveguide of the plurality of waveguides, a signal manipulation element of the first type, and a signal manipulation element of the second type is an optical path defined in three-dimensional space.

In an example embodiment, a waveguide and signal manipulation element defining a portion of an optical path are fabricated and measurement information regarding the function thereof are obtained and a signal manipulation element defining a further portion of the optical path is designed based on the measurement information.

In an example embodiment, the signal manipulation elements of the second type are configured to control one or more optical properties of a respective photonic signal provided to a respective target location, the one or more optical properties including at least one of direction of propagation, wavelength, polarization, relative phase delay, optical mode, or focal location.

In an example embodiment, at least one optical path defined by the signal management system includes at least two signal manipulation elements of the second type that are flood illuminated by a signal manipulation element of the first type such that the at least two signal manipulation elements of the second type concentrate the optical power incident thereon to provide respective photonic signals to respective target locations (which may be the same target location).

In an example embodiment, at least one of (a) at least one of the signal manipulation elements of the second type functions as a beam splitter, or (b) at least one of the signal manipulation elements of the second type functions as a beam combiner.

In an example embodiment, at least one signal manipulation element of the plurality of signal manipulation elements is used as a signal manipulation element of a first type for a first photonic signal and as a signal manipulation element of a second type for a second photonic signal.

In an example embodiment, the first photonic signal is characterized by a first wavelength, the second photonic signal is characterized by a second wavelength, and the first wavelength is shorter than the second wavelength.

According to another aspect, a confinement assembly is provided. In an example embodiment, the confinement assembly includes a confinement apparatus configured to confine a plurality of quantum objects and at least partially defining the plurality of target locations. The confinement assembly further includes a signal management system of an example embodiment.

In an example embodiment, the confinement apparatus is hosted on a first substrate and at least one of (a) at least one waveguide of the plurality of waveguides and at least one signal manipulation element of the plurality of signal manipulation elements is formed on or in the first substrate; or (b) the confinement assembly comprises a second substrate that is secured with respect to the first substrate and at least one waveguide of the plurality of waveguides and at least one signal manipulation element of the plurality of signal manipulation elements is formed on or in the second substrate.

In an example embodiment, an object-facing surface of the first substrate or the second substrate is used to spatially filter optical signals emitted therethrough using total internal reflection.

In an example embodiment, a filter layer is disposed on an object-facing surface of at least one of the first substrate and the second substrate and the filter layer is configured to spatially filter optical signal emitted therethrough.

In an example embodiment, the filter layer comprises a plurality of windows with each window corresponding to a respective target location.

In an example embodiment, the filter layer is optically opaque and the plurality of windows are optically translucent.

According to another aspect, an atomic and/or quantum system is provided. In an example embodiment, the atomic and/or quantum system includes a confinement assembly of an example embodiment and at least one manipulation source configured to generate and/or provide photonic signals to the plurality of waveguides.

In an example embodiment, the atomic and/or quantum system is an atomic qubit or quantum charge-coupled device (QCCD)-based quantum computer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system comprising confinement assembly, in accordance with an example embodiment.

FIG. 2 provides a top view of at least a portion of an example confinement apparatus of an example confinement assembly, in accordance with an example embodiment.

FIGS. 3-6, 9, and 11 provide cross-sectional views of at least portions of various example confinement assemblies, in accordance with various embodiments.

FIGS. 7, 8, 10, 12, and 14 provide perspective views of at least portions of various example confinement assemblies, in accordance with various embodiments.

FIG. 13 provides a schematic view of an object-facing surface of a substrate being used to spatially filter optical signals using total internal reflection, in accordance with various embodiments.

FIG. 15 provides a schematic diagram of an example controller of a system comprising a confinement assembly of an example embodiment, in accordance with various embodiments.

FIG. 16 provides a schematic diagram of an example computing entity of a system comprising a confinement assembly of an example embodiment that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, quantum and/or atomic objects are confined by a confinement apparatus. In various embodiments, a quantum and/or atomic object is an ion; atom; ionic, neutral, and/or multipolar molecule; quantum dot; quantum particle; group, crystal, and/or combination thereof (e.g., an ion crystal comprising two or more ions); and/or the like. In an example embodiment where the quantum and/or atomic objects are ions and/or ion crystals, the confinement apparatus is an ion trap, such as a surface ion trap, Paul ion trap, and/or the like. In various other embodiments, the confinement apparatus is an apparatus configured to confine quantum and/or atomic objects and comprises a plurality of surface electrodes. For example, in various embodiments, the confinement apparatus comprises is formed on a substrate that may include one or more layers including one or more vias, metal routing and/or interconnect layers, photonic/optical layers, and/or the like. A plurality of surface electrodes is formed on the substrate.

In various embodiments, the quantum and/or atomic objects confined by a confinement apparatus are used to perform experiments, controlled quantum state evolution, quantum computations, and/or the like. For example, the confinement apparatus may be part of an atomic system, such as an atomic clock, spectroscopic and/or mass analyzer system, quantum charge-coupled device (QCCD)-based quantum computer, atomic qubit quantum computer, and/or the like.

In various scenarios, it may be desired to confine a large number (e.g., thousands) of quantum and/or atomic objects within a confinement apparatus such that the quantum and/or atomic objects may be interacted with via photonic signals, for example. As confinement apparatuses get larger, integrating optics into the confinement apparatus or another chip look to be a promising way to deliver light to specific locations of the confinement apparatus. However, single layer photonic routing with waveguides has limitations. For example, single layer routing with waveguides has a limited design space which may lead to cross-talk issues between different waveguides. The waveguide routing footprint is also a constraint, especially when many optical and electrical channels (and electrical vias) are needed. Therefore, technical challenges exist regarding how to provide photonic signals to quantum and/or atomic objects confined by a confinement apparatus.

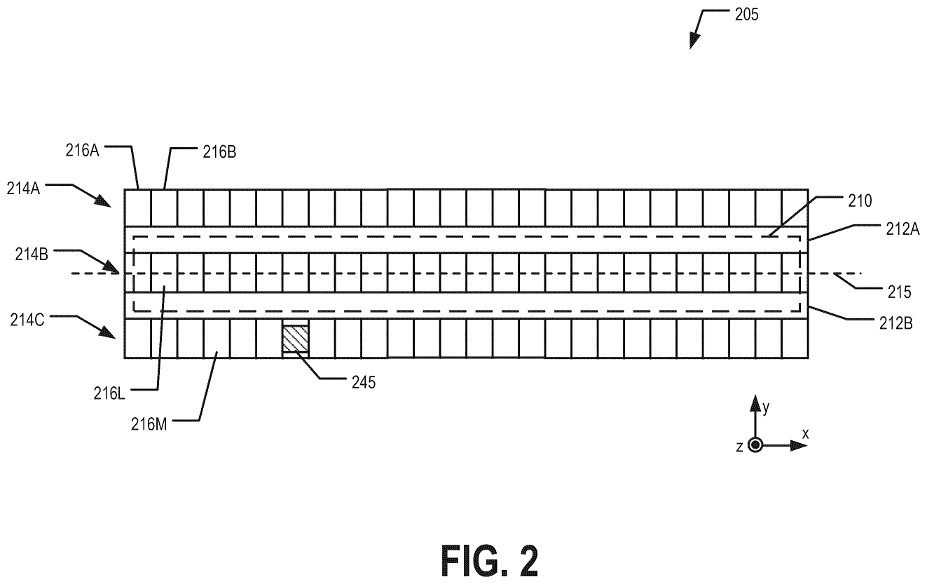

Example embodiments provide technical solutions to these technical problems. Example embodiments provide confinement assemblies that include confinement apparatuses for confining quantum and/or atomic objects and signal management systems that define integrated optical paths for providing photonic signals for interacting with the quantum and/or atomic objects and systems that include such confinement assemblies. In various embodiments, the signal management system includes a plurality of photonic elements (e.g., waveguides, signal manipulation elements of a first type, signal manipulation elements of a second type, and/or the like) that define three-dimensional (3D) integrated optical paths. In various embodiments, the optical paths are defined at least in part by respective waveguides and respective signal manipulation elements. In various embodiments, an optical path includes signal manipulation elements of at least two different types. For example, an optical path may be defined, at least in part, by a first signal manipulation element of a first type, such as a grating coupler, configured to couple the photonic signal out of a respective waveguide. The optical path may be further defined by a second signal manipulation element of a second type, such as a metasurface, configured to control various optical properties of the photonic signal. For example, the second signal manipulation element may change the direction of propagation of the photonic signal such that the photonic signal is incident at a target location that is defined, at least in part, by the confinement apparatus. Through use of the multiple types of signal manipulation elements to define the optical paths and the use of the second signal manipulation element of a second type the technical challenges regarding single layer routing and waveguide routing are overcome. Various technical advantages of such a photonic signal routing system including three-dimensional integrated optical paths are illustrated in FIGS. 2-14 and described herein.

### Exemplary System Comprising a Confinement Assembly

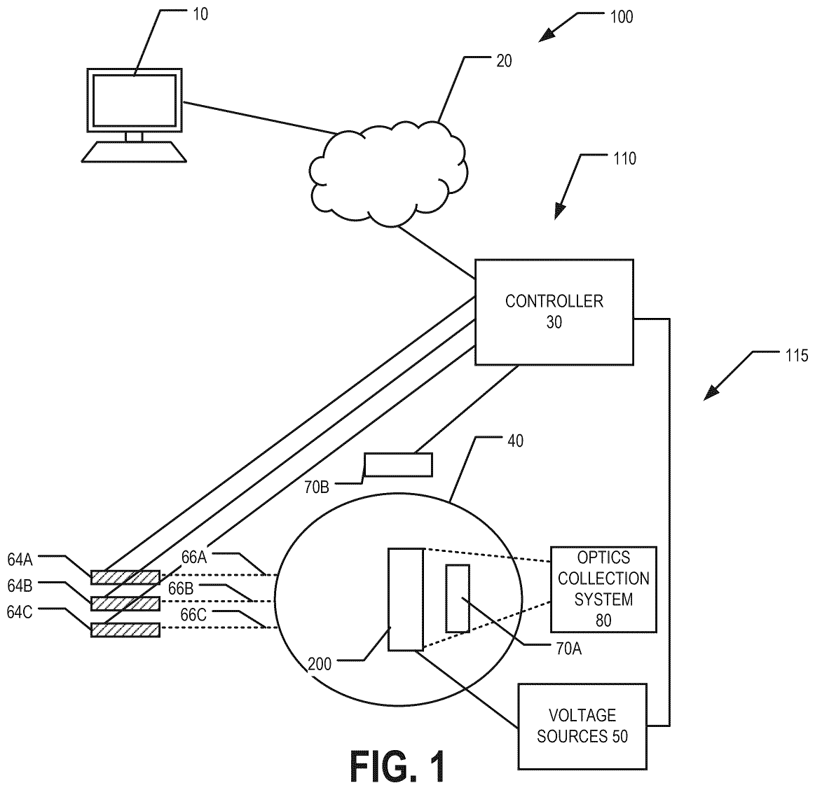

As noted above, various confinement assemblies of various embodiments may be incorporated into various atomic systems, quantum systems, and/or the like. For example, various embodiments provide a system 100 comprising a confinement assembly 200, as shown in FIG. 1. The confinement assembly 200 is configured to confine a plurality of quantum and/or atomic objects such that the respective quantum states of the quantum and/or atomic objects may be manipulated, evolved in a controlled manner (e.g., in accordance with a quantum circuit), and/or the like.

For example, quantum and/or atomic objects may be used as the qubits of a quantum computer 110. For example, quantum operations (single qubit quantum logic gates, two or more qubit quantum logic gates, initialization, reading/detecting operations, cooling operations, and/or the like) may be performed on quantum and/or atomic objects confined by a confinement apparatus 205 (see FIGS. 2-6) of the confinement assembly 200. For example, the confinement apparatus 205 is configured to maintain one or more quantum and/or atomic objects at respective target locations and/or transport quantum and/or atomic objects between respective target locations defined at least in part by the confinement apparatus 205 such that the quantum operation may be performed on the one or more quantum and/or atomic objects.

In various embodiments, the system 100 comprising the confinement assembly 200 comprises one or more manipulation sources 64 (e.g., 64A, 64B, 64C) configured to provide manipulation signals (e.g., laser beams and/or pulses, microwave signals/fields, and/or the like) such that the manipulation signals interact with one or more quantum and/or atomic objects confined at particular target locations defined at least in part by the confinement apparatus. For example, the manipulation signals may include photonic signals provided to respective target locations via the integrated three-dimensional (3D) optical paths.

In various embodiments, the system 100 comprising the confinement assembly 200 comprises one or more magnetic field sources 70 (e.g., 70A, 70B) configured to provide a controlled magnetic field and/or magnetic field gradient at particular locations defined at least in part by the confinement apparatus for use in performing one or more quantum operations on one or more quantum and/or atomic objects confined by the confinement apparatus 205. In various embodiments, the system 100 further comprises an optics collection system 80 configured to collect and/or detect light and/or photons emitted by one or more quantum and/or atomic objects disposed at the particular target locations defined at least in part by the confinement apparatus 205.

In an example embodiment, the system 100 comprising the confinement assembly 200 is and/or includes a quantum charge-coupled device (QCCD)-based quantum computer 110 and/or an atomic-qubit quantum computer. For example, one or more of the quantum and/or atomic objects confined by the confinement apparatus 205 may be used as qubits of the quantum computer 110.

In various embodiments, the system 100 comprises a classical and/or semiconductor-based computing entity 10 and a quantum computer 110. In various embodiments, the quantum computer 110 comprises a controller 30 and a quantum processor 115. In various embodiments, the quantum processor 115 comprises a cryostat and/or vacuum chamber 40 enclosing a confinement assembly 200, one or more manipulation sources 64 (e.g., 64A, 64B, 64C), one or more voltage sources 50, one or more magnetic field sources 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field sources 70, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more quantum and/or atomic objects confined by the confinement apparatus 205. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/detection, and/or like) on quantum and/or atomic objects confined by the confinement apparatus.

In an example embodiment, the one or more manipulation sources 64 each provide a manipulation signal (e.g., laser beam and/or the like) to one or more target locations of the confinement apparatus 205 via corresponding beam path systems 66 (e.g., 66A, 66B, 66C). In various embodiments, at least one beam path system 66 comprises a modulator configured to modulate the manipulation signal being provided to the confinement assembly 200 via the beam path system 66. In various embodiments, a beam path system 65 includes a 3D integrated optical path of the confinement assembly 200.

In various embodiments, a beam path system 66 includes one or more photonic elements (e.g., waveguides, beam splitters, grating couplers, modulators, polarizers, etc.) integrated on the same substrate as the confinement apparatus and/or a photonic integrated circuit (PIC) disposed within the cryostat and/or vacuum chamber 40. For example, the one or more photonic elements may include the two or more signal manipulation elements of an integrated 3D optical path of the confinement assembly 200. In an example embodiment, a beam path system 66 includes one or more optical fibers configured to transport manipulation signals at least partially from a manipulation source 64 to a PIC of the confinement assembly 200 that is formed on the same substrate as the confinement apparatus and/or another substrate configured to be secured with respect to the confinement apparatus (e.g., packaged with the substrate housing the confinement apparatus). In an example embodiment, one or more of the manipulation sources 64 are disposed within the cryostat and/or vacuum chamber 40 (e.g., on the same substrate as the confinement apparatus and/or another substrate configured to be secured with respect to the confinement apparatus). In various embodiments, the manipulation sources 64, modulator, and/or other components of the quantum computer 110 are controlled by the controller 30.

In various embodiments, the confinement apparatus 205 is an ion trap, such as a surface ion trap, Paul ion trap, and/or the like. In various embodiments, the quantum and/or atomic objects are ions; atoms; ion crystals and/or groups; atomic crystals and/or groups; charged, neutral, and/or multipolar molecules; quantum dots; quantum particles; groups, crystals, and/or combinations thereof (e.g., ion crystals); and/or the like. In various embodiments, the confinement apparatus 205 is an appropriate confinement apparatus for confining the quantum and/or atomic objects of the embodiment.

In various embodiments, the quantum computer 110 comprises one or more voltage sources 50. For example, the voltage sources may be arbitrary wave generators (AWG), digital to analog converters (DACs), and/or other voltage signal generators. For example, the voltage sources 50 may comprise a plurality of longitudinal voltage drivers and/or voltage sources and/or at least one RF driver and/or voltage source. The voltage sources 50 may be electrically coupled to the corresponding potential generating elements and/or surface electrodes (e.g., control electrodes and/or RF electrodes) of the confinement apparatus 205, in an example embodiment.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more target locations defined at least in part by the confinement apparatus 205 that has a particular magnitude and a particular magnetic field direction at the one or more target locations.

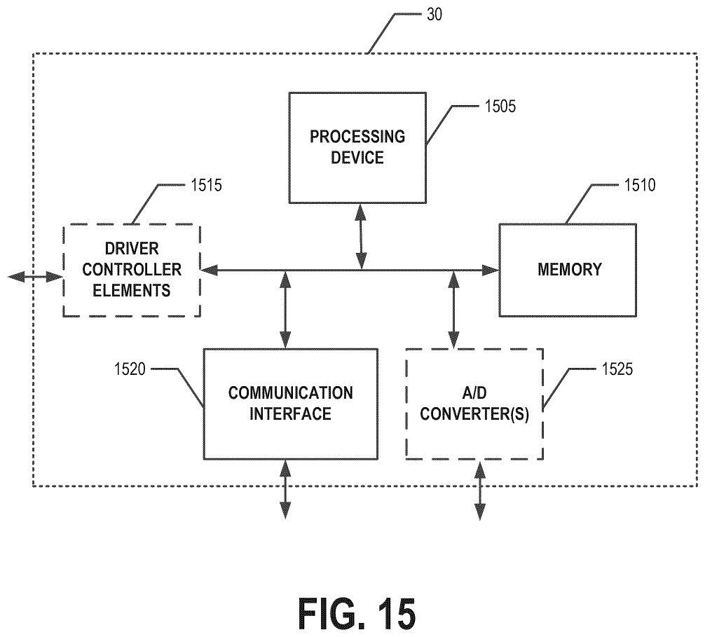

In various embodiments, the quantum computer 110 comprises an optics collection system 80 configured to collect and/or detect photons (e.g., stimulated emission) generated by quantum and/or atomic objects disposed in respective locations (e.g., during reading/detection operations) defined at least in part by the confinement apparatus. The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the atomic objects. While the optics collection system 80 is illustrated as being outside of the cryostat and/or vacuum chamber 40, in various embodiments, one or more optical elements and/or the one or more photodetectors of the optics collection system may be disposed within the cryostat and/or vacuum chamber 40. In various embodiments, the detectors may be in electronic communication with the controller 30 via one or more A/D converters 1525 (see FIG. 15) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more quantum and/or atomic objects within the confinement apparatus, and/or read and/or detect a quantum (e.g., qubit) state of one or more quantum and/or atomic objects confined by the confinement apparatus 205. For example, the controller 30 may cause a controlled evolution of quantum states of one or more quantum and/or atomic objects within the confinement apparatus to execute a quantum circuit and/or algorithm. For example, the controller 30 may read and/or detect quantum states of one or more quantum and/or atomic objects within the confinement apparatus at one or more points during the execution of a quantum circuit. In various embodiments, the quantum and/or atomic objects confined by the confinement apparatus are used as qubits of the quantum computer 110.

### Example Confinement Assembly

In various embodiments, the confinement assembly 200 includes a confinement apparatus configured to confine a plurality of quantum and/or atomic objects and defines, at least in part, a plurality of integrated 3D optical paths. The photonic elements (e.g., waveguides, signal manipulation elements, and/or the like) that define the integrated 3D optical paths are integrated into and/or formed/disposed on and/or in a first substrate hosting the confinement apparatus and/or a second substrate that is secured with respect to the first substrate. The confinement apparatus 205 defines, at least in part, a plurality of target locations and respective optical paths of the plurality of integrated 3D optical paths are configured to provide photonic signals to respective target locations of the plurality of target locations. The photonic signals are configured for interaction with one or more quantum and/or atomic objects confined at the respective target location to cause a controlled evolution of the quantum state(s) of the one or more quantum and/or atomic objects confined at the respective target location. For example, the controlled evolution of the quantum state may include performance of a single qubit gate, a two or more-qubit gate, qubit initialization, quantum state reading/detection, laser cooling, and/or the like.

FIG. 2 provides a top view of at least a portion of an example confinement apparatus 205 that is part of a confinement assembly 200 and that may be used to confine one or more quantum and/or atomic objects. For example, in the illustrated embodiment, the confinement apparatus 205 is an ion trap (e.g., a surface ion trap) and the quantum and/or atomic objects are ions and/or ion crystals. The linear portion of the example confinement apparatus 205 may be part of a larger linear geometry of the confinement apparatus or may be part of a two-dimensional or three-dimensional geometry of the confinement apparatus, in various embodiments.

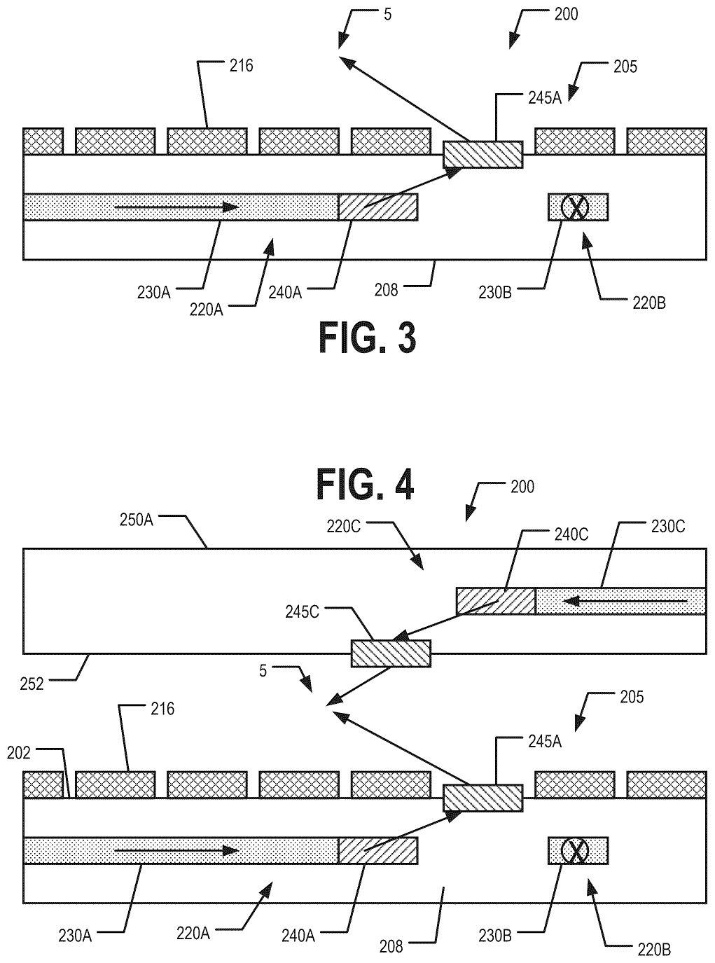

In an example embodiment, the confinement apparatus 205 (e.g., surface ion trap) is fabricated and/or hosted by a first substrate 208, as shown in FIG. 3. The first substrate 208 and the confinement apparatus 205 hosted thereby, are part of the confinement assembly 200. In some embodiments, the confinement assembly 200 also includes one or more second substrates 250 (e.g., 250A, 250B, 250C shown in FIGS. 4-6). For example, the first substrate 208 and the second substrate(s) may be packaged together and/or otherwise secured with respect to one another to provide a confinement assembly 200.

In an example embodiment, the confinement apparatus 205 is at least partially defined by a number of RF electrodes 212 (e.g., 212A, 212B). While the RF electrodes 212 are illustrated as generally rectangular, in various embodiments, the RF electrodes 212 may have various geometries, as appropriate for the application. In various embodiments, the confinement apparatus 205 is at least partially defined by a number of sequences of control electrodes 214 (e.g., 214A, 214B, 214C). Each sequence of control electrodes 214 comprises a plurality of control electrodes 216 (e.g., 216A, 216B, . . . , 216L, 216M). While the control electrodes 216 are illustrated as generally rectangular, in various embodiments, the control electrodes 216 may have various geometries, as appropriate for the application.

In an example embodiment, each control electrode 216 and/or at least a non-empty subset of the control electrodes 216 may be operated independently via the application of control signals thereto. In an example embodiment, at least some of the control electrodes 216 are operated via application of a broadcast control signal. In an example embodiment, the confinement apparatus 205 is a surface Paul trap with symmetric RF electrodes 212. In various embodiments, the RF electrodes 212 and the control electrodes 216 generate potentials and/or fields that are experienced by atomic objects within respective confinement regions of the confinement apparatus 205. In particular, the RF electrodes 212 may be configured to define the respective confinement regions 210 of the confinement apparatus 205 and the control electrodes 216 may be configured to at least partially control movement and/or motion of quantum and/or atomic objects within the respective confinement regions.

FIG. 3 illustrates a portion of an example embodiment of a confinement assembly that includes a first substrate having a plurality of potential generating elements (e.g., RF electrodes 212, control electrodes 216) formed thereon. The plurality of potential generating elements is operable to generate the confinement potential of the confinement apparatus 205. In other words, the confinement apparatus 205 is hosted by the first substrate 208. In various embodiments, the first substrate 208 also hosts photonic elements that at least partially define a plurality of integrated 3D optical paths 220 (e.g., 220A, 220B).

In an example embodiment, an optical path 220 is defined at least in part by photonic elements such as a waveguide 230 (e.g., 230A, 230B) and signal manipulation elements 240, 245. For example, a photonic signal (e.g., generated by a manipulation source 64) may be provided to a waveguide 230A. The waveguide 230A guides the photonic signal to the signal manipulation element of the first type 240, which couples the photonic signal out of the waveguide 230A and directs the photonic signal toward the signal manipulation element of the second type 245. The signal manipulation element of the second type 245 directs the photonic signal toward the target location 5.

In various embodiments, an optical path includes signal manipulation elements of at least two different types. For example, an optical path 220A is defined at least in part by a waveguide 230A, a manipulation element of a first type 240, and a manipulation element of a second type 245. For example, a signal manipulation element of a first type 240 is configured to couple the photonic signal out of a respective waveguide 230A. In an example embodiment, a signal manipulation of a first type 240 is a grating coupler. A signal manipulation element of a second type 245 is configured to control various optical properties of the photonic signal. For example, the signal manipulation element of a second type 245 may change the direction of propagation of the photonic signal such that the photonic signal is incident at a target location that is defined, at least in part, by the confinement apparatus. The signal manipulation element of the second type 245 may control additional optical properties of the photonic signal (e.g., in addition to direction of propagation) including one or more of wavelength, polarization, relative phase delay, optical mode, focal location, and/or the like.

As shown in FIG. 3, waveguides 230 of the confinement assembly 200 may be configured to guide photonic signals in various directions. For example, the direction of propagation along waveguide 230A is perpendicular to the direction of propagation along waveguide 230B.

In various embodiments, the signal manipulation elements of the first type 240 are configured to couple a guided mode photonic signal out of waveguide 230 into a free space mode photonic signal. For example, signal manipulation elements of the first type 240 may be various types of couplers, such as grating couplers and/or the like.

In various embodiments, the signal manipulation elements of the second type 245 are configured to change the direction of propagation of a free space mode photonic signal. In various embodiments, the signal manipulation elements of the second type 245 are further configured to control one or more additional optical properties of the photonic signal. For example, in various embodiments, the one or more additional optical properties of the photonic signal (e.g., in addition to direction of propagation) may include one or more of wavelength, polarization, relative phase delay, optical mode, focal location, and/or the like. In an example embodiment, the signal manipulation elements of the second type 245 are metasurfaces, lenses, waveplates, gratings, diffractive optical elements (DOEs), and/or the like.

FIG. 4 illustrates a portion of an example confinement assembly 200 that includes a first substrate 208 hosting a confinement apparatus 205 and the photonic elements that define a first optical path 220A and a second optical path 220C. The confinement assembly 200 also includes a second substrate 250A that is secured with respect to the first substrate 208. In particular, the second substrate 250A is secured with respect to the first substrate 208 such that an object-facing surface 252 of the second substrate 250A is substantially parallel to an object-facing surface 202 of the first substrate 208.

The second substrate 250A hosts photonic elements such as waveguide 230C, signal manipulation element of the first type 240C, and signal manipulation element of the second type 245C, that define a second optical path 220C. For example, the first optical path 220A and the second optical path 220C provide respective photonic signals to the target location 5. In various embodiments, various optical paths defined at least in part by photonic elements (e.g., waveguides 230, signal manipulation elements of the first type 240, signal manipulation elements of the second type 245) hosted on the first substrate 208 and various optical paths defined at least in part by photonic elements (e.g., waveguides 230, signal manipulation elements of the first type 240, signal manipulation elements of the second type 245) hosted on the second substrate 250, may provide respective photonic signals to various target locations 5 defined at least in part by the confinement apparatus 205.

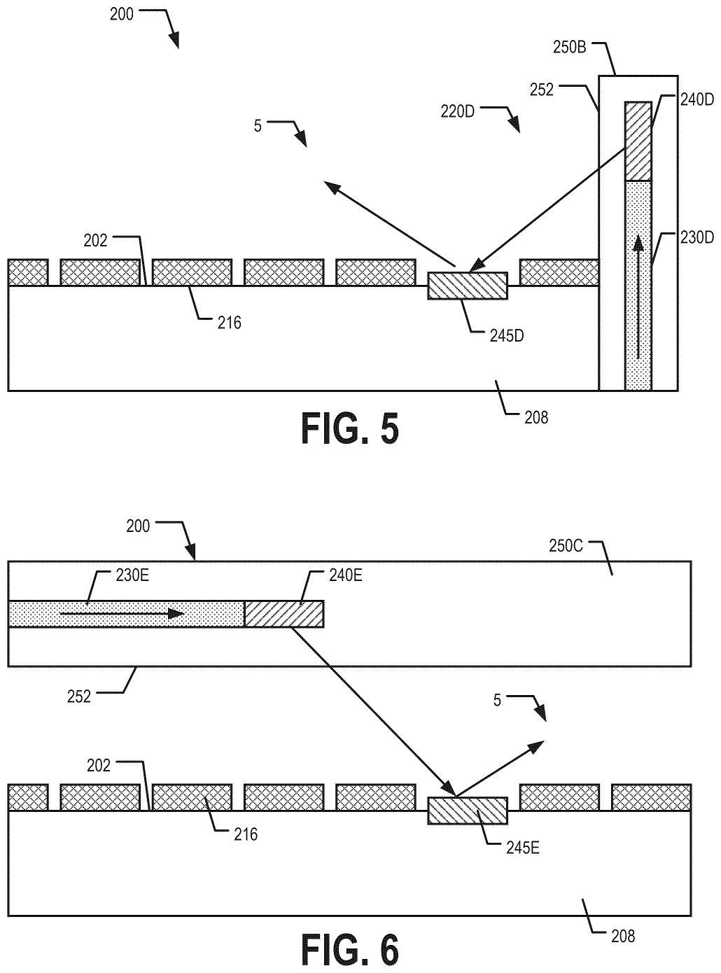

FIG. 5 illustrates an example confinement assembly 200 where an object-facing surface 252 of the second substrate 250B is transverse (e.g., perpendicular and/or not-parallel) to the object-facing surface 202 of the first substrate 208. In the illustrated embodiment, the second substrate 250B hosts at least a waveguide 230D and a signal manipulation element of a first type 240D. In some embodiments, the second substrate 250B may also host signal manipulation elements of a second type. The waveguide 230D and the signal manipulation element of the first type 240D define a portion of the optical path 220D. A signal manipulation element of the second type 245D, hosted by the first substrate 208, defines a final portion of the optical path 220D. For example, optical paths 220 may be defined by photonic elements hosted on a combination of the first substrate 208 and the second substrate 250.

FIG. 6 illustrates an example confinement assembly 200 where the second substrate 250C hosts waveguides (e.g., waveguide 230E), signal manipulation elements of the first type (e.g., signal manipulation element of the first type 240E), and possibly signal manipulation elements of the second type 245. The first substrate 208 may host signal manipulation elements of the second type (e.g., signal manipulation element of the second type 245E), but need not include waveguides or signal manipulation elements of the first type. For example, the first substrate 208 may include photonic elements (e.g., signal manipulation element of the second type 245E) that are formed on an object-facing surface 202 of the first substrate 208 and/or that are not embedded within the first substrate 208. For example, FIG. 6 illustrates an example embodiment where the first substrate 208 may not include an embedded optical and/or photonic routing/interposer layer.

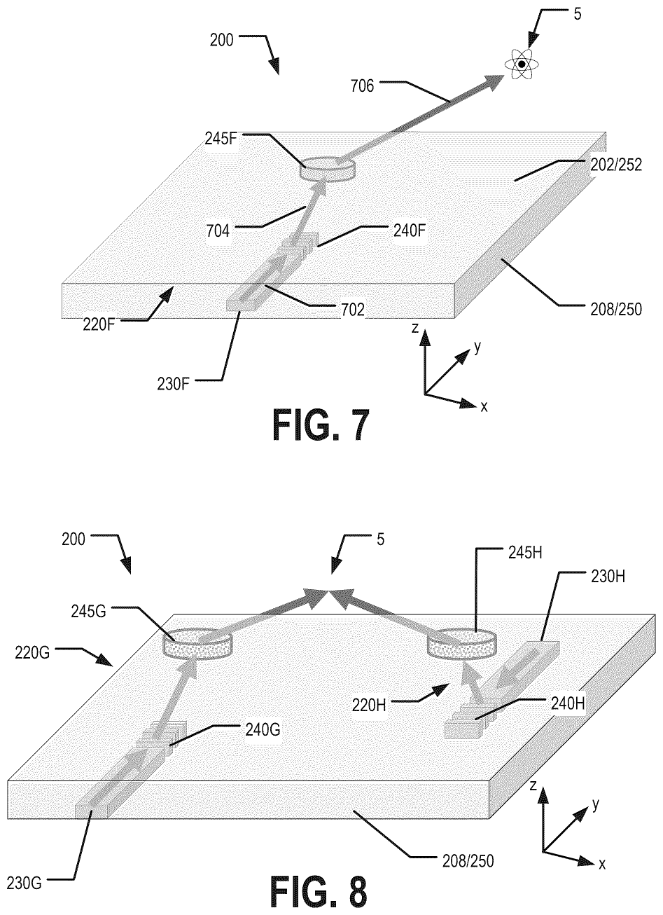

FIG. 7 illustrates an example portion of a confinement assembly 200 where a substrate (e.g., first substrate 208 or second substrate 250) hosts a waveguide 230F, a signal manipulation element of a first type 240F, and a signal manipulation element of a second type 245F. The waveguide 230F, signal manipulation element of a first type 240F, and signal manipulation element of a second type 245F collectively define an optical path 220F that is integrated with the confinement assembly 200. For example, the alignment of the optical path 220F with the target location 5 is generally stable independent of routine alignment calibration activities.

Moreover, the waveguide 230F, signal manipulation element of a first type 240F, and signal manipulation element of a second type 245F collectively define an optical path 220F that is three-dimensional. For example, the direction of propagation 702 of the photonic signal guided along the waveguide 230F (e.g., as a guided mode) is substantially within a plane that is parallel to the object-facing surface 202, 252 of the substrate (e.g., first substrate 208 or second substrate 250) hosting the photonic elements. The signal manipulation element of the first type 240F (e.g., a grating coupler) couples the photonic signal out of the waveguide 230F such that the photonic signal propagates (e.g., as a free space mode) in a direction of propagation 704 that has a non-zero component that is parallel to the direction of propagation 702 along the waveguide 230F and that also includes a non-zero component in a direction out of a plane where the plane is parallel to the object-facing surface 202, 252 of the substrate (e.g., first substrate 208 or second substrate 250) hosting the photonic elements.

The photonic signal is incident on the signal manipulation element of the second type 245F. The signal manipulation element of the second type 245F changes the direction of propagation of the photonic signal to direct the photonic signal along direction of propagation 706 toward the target location 5. For example, the signal manipulation element of the second type 245F may cause the photonic signal to propagate in a direction of propagation 706 that is out of a plane defined by the direction of propagation 702 of the photonic signal along the waveguide 230F and the direction of propagation 704 of photonic signal between the signal manipulation element of the first type 240F and the signal manipulation element of the second type 245F.

For example, the direction of propagation 702 of the photonic signal along the waveguide 230F is in the y direction. The direction of propagation 704 of the photonic signal as a result of the photonic signal interacting with the signal manipulation element of the first type 240F has non-zero components in the y direction and the z direction (and a zero component in the x direction). The direction of propagation 702 and the direction of propagation 704 therefore define a plane parallel to the yz plane. The direction of propagation 706 of the photonic signal as a result of the photonic signal interacting with the signal manipulation element of the second type 245F may have a non-zero component in the x direction. Additionally, the interaction of the photonic signal with the signal manipulation element of the second type 245F may cause the y and z components of the direction of propagation of the photonic signal to also change. For example, the component of the direction of propagation 706 in the y direction may be different from the component of the direction of propagation 704 in the y direction as a result of the photonic signal interacting with the signal manipulation element of the second type 245F. For example, the component of the direction of propagation 706 in the z direction may be different from the component of the direction of propagation 704 in the z direction as a result of the photonic signal interacting with the signal manipulation element of the second type 245F.

By using the signal manipulation element of the second type 245F to redirect the photonic signal toward the target location 5, the target location 5 may be arbitrarily positioned with respect to the direction of propagation 702 of the photonic signal propagating along the waveguide 230F and with respect to the location of the signal manipulation element of the first type 240F.

In various embodiments, the signal manipulation element of the second type 245F may control additional optical properties of the photonic signal (e.g., in addition to direction of propagation) including one or more of wavelength, polarization, relative phase delay, optical mode, focal location, and/or the like. Thus, use of the signal manipulation element of the second type 245F to convert the polarization, optical mode, wavelength, relative phase delay, focal location, and/or other optical property of the photonic signal to a desired set of optical properties for when the photonic signal interacts with quantum and/or atomic objects at the target location 5, enables the waveguide 230F and the signal manipulation element of the first type 240F to be designed and/or configured for low loss and/or other desired properties without being constrained by the desired set of optical properties for when the photonic signal interacts with quantum and/or atomic objects at the target location 5.

In various scenarios, interactions with one or more quantum and/or atomic objects at a target location 5 is performed using two (or more) photonic signals that are not co-propagating (e.g., that are not approaching the target location 5 from the same direction). FIG. 8 illustrates an example scenario a first photonic signal and a second photonic signal are provided to the target location 5 from different directions where projections of the directions in a plane parallel to the object-facing surface of the substrate that are opposite. For example, in FIG. 8, the first photonic signal provided to the target location 5 via the optical path 220G has a direction of propagation where the components in the x and y directions are opposite the respective x and y direction components of the direction of propagation of a second photonic signal provided to the target location 5 via the optical path 220H.

As shown in FIG. 8, an optical path 220G is defined by a waveguide 230G, a signal manipulation element of the first type 240G, and a signal manipulation element of the second type 245G and an optical path 220H is defined by a waveguide 230H, a signal manipulation element of the first type 240H, and a signal manipulation element of the second type 245H. The direction of propagation of a first photonic signal along the waveguide 230G is in the positive y direction, as illustrated. The direction of propagation of a second photonic signal along the waveguide 230H is in the negative y direction, as illustrated.

If the optical paths 220G, 220H did not include the signal manipulation elements of the second type 245G, 245H, the waveguides 230G, 230H would need to be aligned with one another. For example, the direction of propagation of the first photonic signal along the waveguide 230G and the direction of propagation of the first photonic signal as a result of interacting with the signal manipulation element of the first type 240G would define a first plane and the direction of propagation of the second photonic signal along the waveguide 230H and the direction of propagation of the second photonic signal as a result of interacting with the signal manipulation element of the first type 240H would define a second plane that is parallel to the first plane. The target location 5 would need to be in both the first plane and the second plane. Therefore, the first plane and the second plane would be the same plane and the waveguides 230G, 230H would be aligned with one another. This configuration may allow any portion of the first photonic signal that was not coupled out of the waveguide 230G by signal manipulation element of the first type 240G to couple into the waveguide 230H. Similarly, any portion of the second photonic signal that was not coupled out of the waveguide 230H by signal manipulation element of the first type 240H may couple into the waveguide 230G. The resulting cross-talk between the first photonic signal and the second photonic signal may lead to various errors and/or low fidelity of the quantum operation performed by the first photonic signal and the second photonic signal interacting with atomic and/or quantum objects at the target location 5.

Through the use of the signal manipulation elements of the second type 245G, 245H, the waveguides 230G, 230H may be unaligned with one another (e.g., the first plane and the second plane may be different planes because the target location 5 need not be in either of the first or second planes). As such, cross-talk between the waveguides 230G, 230H caused by the waveguides 230G, 230H being aligned with one another is prevented.

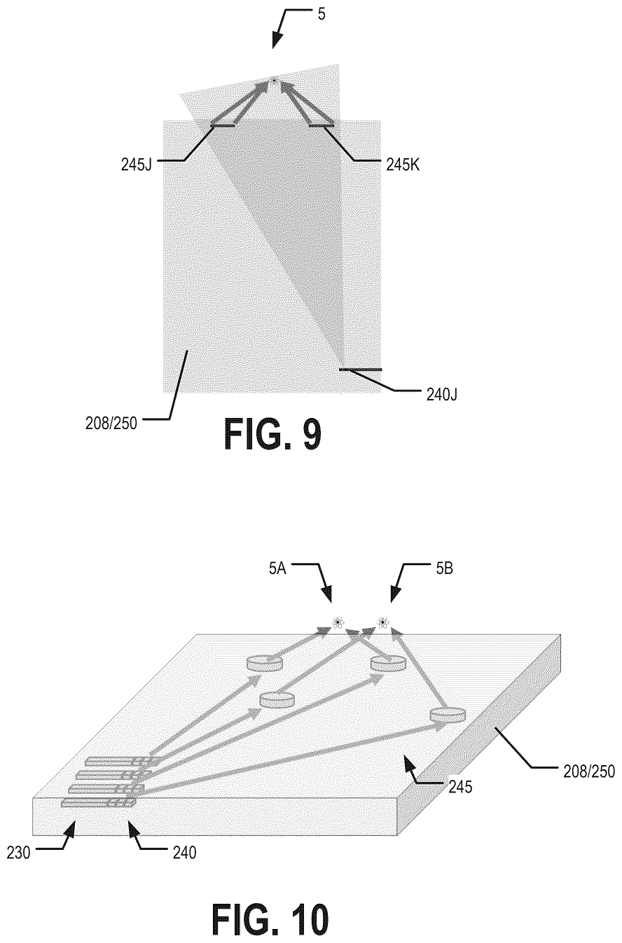

FIG. 9 illustrates an example of providing two similar photonic signals to a target location 5 from different directions. For example, a signal manipulation element of the first type 240J is coupled to a photonic signal out of a waveguide that is not shown. The photonic signal diverges as it propagates such that the photonic signal is incident on more than one (e.g., two or more) signal manipulation elements of the second type 245J, 245K. For example, the signal manipulation elements of the second type 245J, 245K may be flood illuminated by the photonic signal coupled out of the waveguide by the signal manipulation element of the first type 240J. The term flood illuminate is used herein to indicate that the photonic signal has a large cross-sectional area (e.g., in a plane parallel to the signal manipulation elements of the second type 245J, 245K). For example, a diameter of the cross-section (in a plane that includes the signal manipulation elements of the second type 245J, 245K) of the photonic signal is large enough illuminate at least both of the signal manipulation elements of the second type 245J, 245K.

The two or more signal manipulation elements of the second type 245J, 245K may each interact with a respective portion of the photonic signal to cause respective photonic signal portions to be incident on the target location. For example, the signal manipulation elements of the second type 245J, 245K may have respective surface areas that are larger than the surface area of the target location 5 into which the signal manipulation elements of the second type 245J, 245K are focusing the respective portions of the photonic signal. Thus, the portions of the photonic signal that are projected onto the target location 5 by the signal manipulation elements of the second type 245J, 245K have a higher intensity (e.g., power per area) than the diverged photonic signal that was incident on the signal manipulation elements of the second type 245J, 245K. For example, the signal manipulation elements of the second type 245J, 245K may concentrate respective portions of the photonic signal onto the target location 5.

FIG. 10 illustrates an example embodiment where a substrate (e.g., the first substrate 208 or the second substrate 250) hosts a plurality of waveguides 230, a plurality of signal manipulation elements of the first type 240, and a plurality of signal manipulation elements of the second type 245 that define a plurality of optical paths to provide photonic signals to a plurality of target locations 5A, 5B. The design flexibility provided by this combination of photonic elements to define the 3D optical paths in an integrated manner enable a simplified routing of the waveguides 230 in the optical and/or photonic routing/interposer layer(s) of the substrate. In some instances, a plurality of vias (e.g., through silicon vias (TSVs)) and/or other electronic components may need to pass through the optical and/or photonic routing/interposer layer(s) of the substrate. The design flexibility provided by this combination of photonic elements to define the 3D optical paths in an integrated manner enables a large number of vias and/or other electrical components while providing effective routing of the waveguides 230 in the optical and/or photonic routing/interposer layer(s) of the substrate.

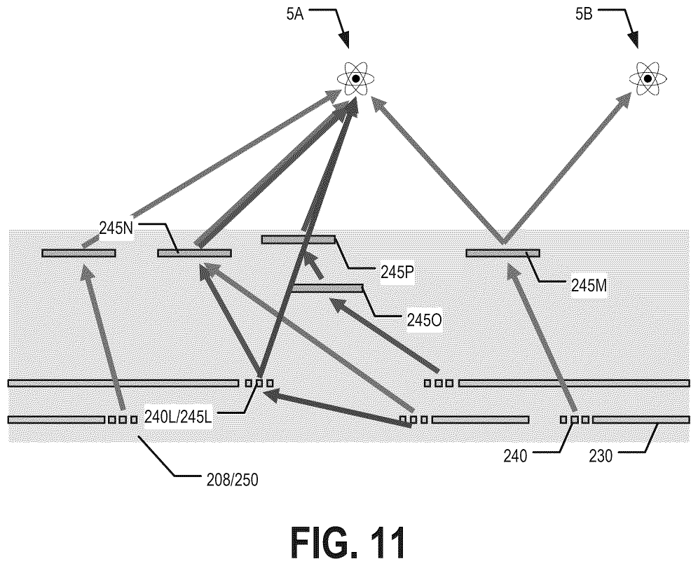

Moreover, as shown in FIG. 11, in various embodiments, multiple optical and/or photonic routing/interposer layers may be included in a substrate (e.g., first substrate 208, second substrate 250). In some scenarios, signal manipulation elements of the second type 245 may be used to perform functions such as beam splitting (e.g., as is the case for signal manipulation element of the second type 245M) or beam combining (e.g., as is the case for signal manipulation element of the second type 245N). In some instances, an optical path may include two or more signal manipulation elements of the second type, as is the case for the optical path including signal manipulation elements of the second type 245O, 245P.

In some scenarios, the wavelengths of the various photonic signals to be provided to respective target locations 5 of the confinement apparatus 205 may vary over a wide range of wavelengths. For example, some of the photonic signals may be at blue to ultraviolet wavelengths while other photonic signals may be in the infrared to red range. FIG. 11 illustrates an example of such an embodiment. In such an embodiment, a signal manipulation element may be configured to act as a signal manipulation element of the first type 240L for a first wavelength photonic signal and to act as a signal manipulation element of the second type 245L for a second wavelength photonic signal. For example, the features of the signal manipulation element (e.g., ridges, pillars, holes, and/or other modulation of the refractive index) may be characterized by a size scale that is approximately equal to or larger than the wavelength of photonic signal in the blue to ultraviolet wavelength range. These same features of the signal manipulation element are characterized by a size scale that is smaller than the wavelength of a photonic signal in the infrared to red wavelength range. Thus, the same signal manipulation element may be a signal manipulation element of the first type 240L when interacting with a shorter wavelength photonic signal (e.g., characterized by a wavelength that is shorter than the wavelength that characterizes the longer wavelength photonic signal) and may be a signal manipulation element of the second type 245L when interacting with a longer wavelength photonic signal (e.g., characterized by a wavelength that is longer than the wavelength that characterizes the shorter wavelength photonic signal).

In various scenarios, real-life waveguides 230, signal manipulation elements of the first type 240, and signal manipulation elements of the second type 245 are not perfect photonic elements. For example, some optical power of a photonic signal may be leaked out of waveguide 230 as the photonic signal propagates along the waveguide. In another example, some optical power of a photonic signal coupled out of a waveguide by a signal manipulation element of the first type 240 may be coupled into a free space mode that does not propagate toward the signal manipulation element of the second type of the optical path. In yet another example, some optical power of a photonic signal that interacts with a signal manipulation element of the second type 245 may be in a mode other than the first or primary mode of the signal manipulation element of the second type 245 (e.g., may not be directed toward the target location 5). Generally, the optical power that is leaked out of an optical path as a result of the real-life photonic elements not being perfect is not directed toward the target location 5 corresponding to the optical path. However, the leaked optical power may interact with other quantum and/or atomic objects confined by the confinement apparatus 205 and cause heating of the quantum and/or atomic objects and/or other errors to occur.

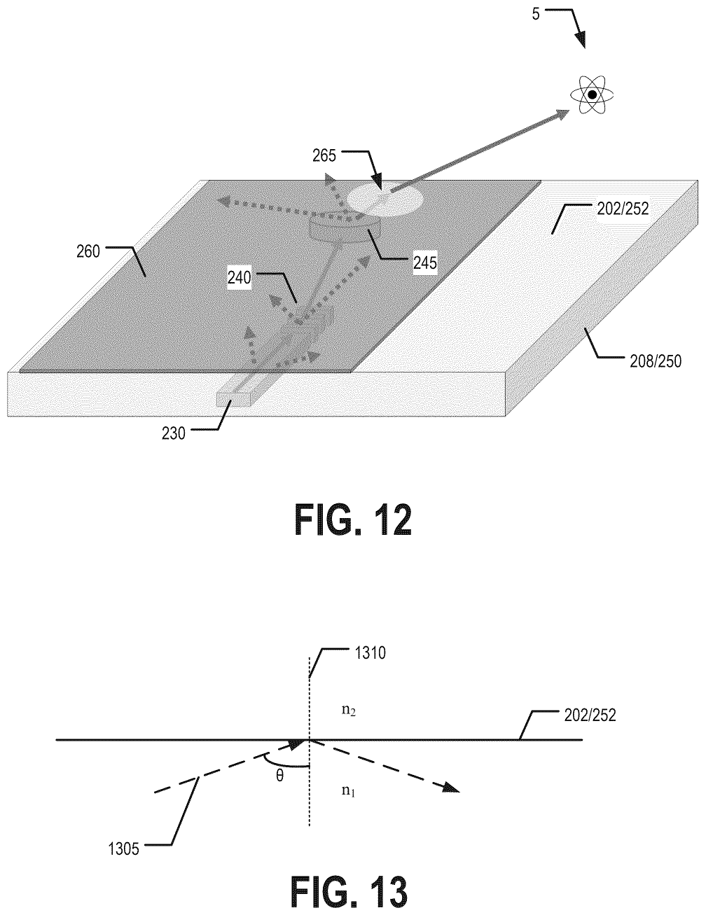

Various embodiments provide for spatial filtering of the leaked optical power such that interaction of the leaked optical power with quantum and/or atomic objects confined by the confinement apparatus is prevented. FIG. 12 illustrates an example embodiment where a filter layer 260 is applied to and/or disposed on the object-facing surface 202, 252 of the substrate (e.g., the first substrate 208, the second substrate 250). In various embodiments, the filter layer 260 is configured to spatially filter optical power exiting the substrate such that the photonic signals are provided to the target location 5 and the leaked optical power is not able to interact with the quantum and/or atomic objects confined by the confinement apparatus 205. In various embodiments, the filter layer 260 comprises a metal material and/or other optically opaque material. For example, the filter layer 260 may be configured to absorb or reflect leaked optical power incident thereon.

The filter layer 260 includes window 265 corresponding to target location 5. For example, the filter layer 260 may comprise a plurality of windows 265 with each window corresponding to a respective target location 5. In some instances, a particular target location 5 may correspond to a plurality of windows 265. For example, the confinement assembly 200 may be configured to provide a plurality of photonic signals to the target location 5 from various directions and each of those photonic signals may be provided via a respective window 265. For example, the windows 265 may be openings (e.g., through holes) in the filter layer 260 or may comprise an optically translucent material (e.g., at least for a wavelength characterizing a photonic signal to be emitted therethrough) embedded in the filter layer 260.

The windows 265 are sized and positioned such that photonic signals that are provided to corresponding target locations 5 are provided therethrough and the emission of leaked optical power through the object-facing surface 202, 252 is reduced and/or minimized (compared to if the filter layer 260 was not present).

In some embodiments, the photonic signals and/or the photonic elements (e.g., waveguides 230, signal manipulation elements of the first type 240, and signal manipulation elements of the second type 245) are configured such that the object-facing surface 202, 252 itself acts as a filtering layer and/or enacts physical filtering of the optical power emitted therethrough. For example, in various embodiments, the signal manipulation elements of the first type 240 are configured and/or designed to couple the photonic signals out of the respective waveguides 230 such that, without interacting with the signal manipulation elements of the second type 245, the photonic signals would interact with the object-facing surface 202, 252 of the substrate at a grazing angle, resulting in total internal reflection thereof.

For example, FIG. 13 illustrates a scenario where an optical signal, such as a photonic signal or leaked optical power that was provided to the confinement assembly 200 as part of a photonic signal, interacts with the object-facing surface 202, 252 such that an angle θ is formed between the direction of propagation of the optical signal 1305 and a normal to the object-facing surface 202, 252 at the point of interaction (e.g., a line that is perpendicular to the object-facing surface 202, 252 at the point where the optical signal 1305 is incident on the object-facing surface 202, 252). If the angle θ is larger than a critical angle φ, the optical signal 1305 experiences total internal reflection. In other words, substantially all of the optical signal 1305 is reflected off the object-facing surface and substantially none of the optical signal 1305 is transmitted through the surface. The critical angle φ is a function of the indexes of refection n₁, n₂ on either side of the interface (e.g., the object-facing surface 202, 252). For example, critical angle φ is equal to the arcsine of the ratio of the index of refraction outside of the substrate n₂ to the index of refraction of the substrate n₁.

Thus, in an example embodiment, one or more photonic elements (e.g., waveguides 230, signal manipulation elements of the first type 240, and signal manipulation elements of the second type 245) are configured such that optical signals other than the desired photonic signals interact with the object-facing surface at an angle θ that is larger than or equal to a critical angle φ for the interface of the object-facing surface 202, 252. For example, a signal manipulation element of the first type 240 emits a photonic signal (e.g., couples the photonic signal out of a corresponding waveguide 230) at an angle that would be filtered via total internal reflection. A signal manipulation element of the second type 245 may be positioned along the trajectory of the photonic signal to deflect at least a portion of the photonic signal to an angle θ that is smaller than the critical angle φ to enable transmission of the at least a portion of the photonic signal through the object-facing surface 202, 252. For example, the signal manipulation elements of the second type 245 are configured to provide the desired photonic signals toward the respective target locations 5 at angles θ that are smaller than the critical angle φ for the interface of the object-facing surface 202, 252 such that the desired photonic signals are transmitted through the object-facing surface 202, 252 toward the respective target locations 5.

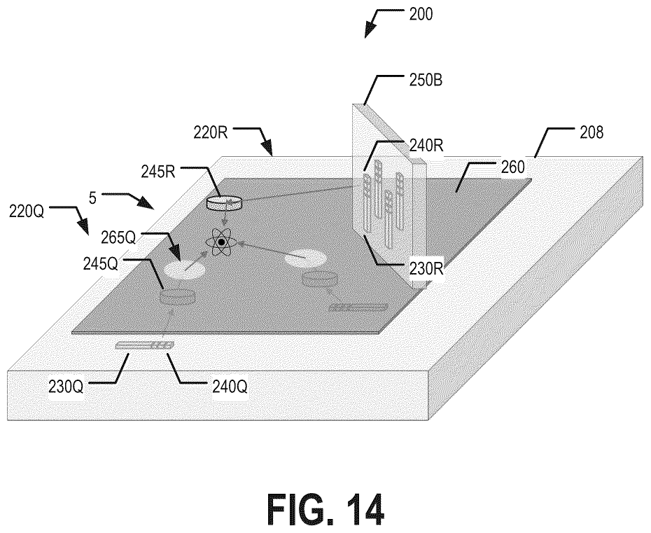

FIG. 14 illustrates an example portion of a confinement assembly 200 comprising photonic elements that define optical paths where some of the optical paths are disposed such that a filter layer 260 is disposed between at least a portion of the optical path and the target location 5 and some of the optical paths are disposed such that the filter layer 260 is not disposed between any portion of the optical path and the target location 5. For example, waveguide 230Q, signal manipulation element of the first type 240Q, and signal manipulation element of the second type 245Q define optical path 220Q and are disposed on or in the first substrate 208. A filtering layer is disposed on the object-facing surface 202 of the first substrate 208. The optical path 220Q passes through a corresponding window 265Q in the filter layer 260. A second substrate 250B hosts a waveguide 230R and signal manipulation element of the first type 240R which, along with the signal manipulation element of the second type 245R, define optical path 220R. The signal manipulation element of the second type 245R is disposed on the same side of the filter layer 260 as the target location 5.

### Technical Advantages

In various scenarios, it may be desired to confine a large number (e.g., thousands) of quantum and/or atomic objects within a confinement apparatus such that the quantum and/or atomic objects may be interacted with via photonic signals, for example. As confinement apparatuses get larger, integrating optics into the confinement apparatus or another chip look to be a promising way to deliver light to specific locations of the confinement apparatus. However, single layer photonic routing with waveguides has limitations. For example, single layer routing with waveguides has a limited design space which may lead to cross-talk issues between different waveguides. The waveguide routing footprint is also a constraint, especially when many optical and electrical channels (and electrical vias) are needed. Therefore, technical challenges exist regarding how to provide photonic signals to quantum and/or atomic objects confined by a confinement apparatus.

Example embodiments provide technical solutions to these technical problems. Example embodiments provide confinement assemblies that include confinement apparatuses for confining quantum and/or atomic objects and integrated optical paths for providing photonic signals for interacting with the quantum and/or atomic objects and systems that include such confinement assemblies. In various embodiments, the optical paths are defined at least in part by respective waveguides and respective signal manipulation elements. In various embodiments, an optical path includes signal manipulation elements of at least two different types. For example, an optical path may be defined, at least in part, by a first signal manipulation element of a first type, such as a grating coupler, configured to couple the photonic signal out of a respective waveguide. The optical path may be further defined by a second signal manipulation element of a second type, such as a metasurface, configured to control various optical properties of the photonic signal. For example, the second signal manipulation element may change the direction of propagation of the photonic signal such that the photonic signal is incident at a target location that is defined, at least in part, by the confinement apparatus. Through use of the multiple types of signal manipulation elements to define the optical paths and the use of the second signal manipulation element of a second type the technical challenges regarding single layer routing and waveguide routing are overcome. Thus, various technical improvements are provided by various embodiments to the technical fields of photonic signal delivery, quantum and/or atomic object manipulation, quantum computing, and/or the like.

### Example Controller

Various embodiments provide systems comprising confinement assemblies 200. For example, various atomic systems, quantum systems, and/or the like may use a confinement assembly 200 comprising a confinement apparatus 205 and a plurality of integrated 3D optical paths to confine and interact with one or more quantum and/or atomic objects. In an example embodiment, the system is a quantum charge-coupled device (QCCD-based) quantum computer 110, atomic qubit quantum computer, or other quantum computer. In various embodiments, the system (e.g., quantum computer 110) includes a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 64 (e.g., 64A, 64B, 64C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more quantum and/or atomic objects confined by the confinement apparatus, and/or read and/or detect a quantum state of one or more quantum and/or atomic objects confined by the confinement apparatus.

As shown in FIG. 15, in various embodiments, the controller 30 may comprise various controller elements including one or more processing devices 1505, memory 1510, driver controller elements 1515, a communication interface 1520, analog-digital converter elements 1525, and/or the like. For example, the one or more processing devices 1505 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 1505 of the controller 30 comprises a clock and/or is in communication with a clock. In various embodiments, this clock defines the clock cycles of the system.

For example, the memory 1510 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1510 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 1510 (e.g., by a processing device 1505) causes the controller 30 to perform one or more steps, operations, processes, procedures and/or the like described herein for controlling one or more components of the quantum computer 110 (e.g., voltage sources 50, manipulation sources 64, magnetic field sources 70, and/or the like) to cause a controlled evolution of quantum states of one or more quantum and/or atomic objects, detect and/or read the quantum state of one or more quantum and/or atomic objects, and/or the like.

In various embodiments, the driver controller elements 1515 may include one or more drivers and/or controller elements each configured to control one or more drivers. In various embodiments, the driver controller elements 1515 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 1505). In various embodiments, the driver controller elements 1515 may enable the controller 30 to operate a manipulation source 64. In various embodiments, the drivers may be laser drivers; vacuum component drivers; drivers for controlling the flow of current and/or voltage applied to the electrodes (e.g., the RF, control, and/or other electrodes of the confinement apparatus 205) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the electrodes (e.g., control electrodes 216 and/or RF electrodes 212). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 1525 configured to receive signals from one or more detectors, optical receiver components, calibration sensors, and/or the like.

In various embodiments, the controller 30 may comprise a communication interface 1520 for interfacing and/or communicating with one or more computing entities 10. For example, the controller 30 may comprise a communication interface 1520 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Example Computing Entity

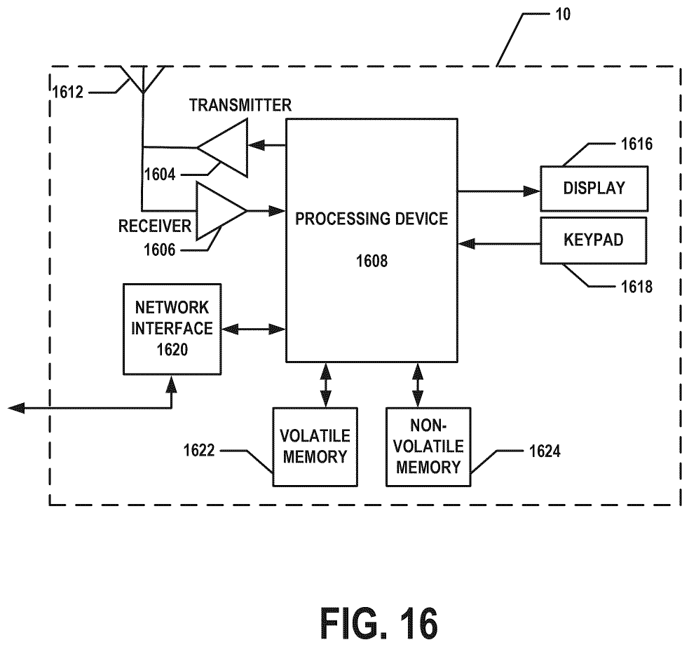

FIG. 16 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 16, a computing entity 10 can include an antenna 1612, a transmitter 1604 (e.g., radio), a receiver 1606 (e.g., radio), and a processing device 1608 that provides signals to and receives signals from the transmitter 1604 and receiver 1606, respectively.

The signals provided to and received from the transmitter 1604 and the receiver 1606, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 1620 configured to communicate via one or more wired and/or wireless networks 20.

The computing entity 10 may also comprise a user interface device comprising one or more user input/output interfaces (e.g., a display 1616 and/or speaker/speaker driver coupled to a processing device 1608 and a touch screen, keyboard, mouse, and/or microphone coupled to a processing device 1608). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1618 (hard or soft), a touch display, voice/speech or motion interfaces, scanners, readers, or other input device. In embodiments including a keypad 1618, the keypad 1618 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1622 and/or non-volatile storage or memory 1624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A signal management system configured to provide photonic signals to a plurality of target positions defined at least in part by a confinement apparatus configured to confine a plurality of quantum objects, the signal management system comprising:
a plurality of waveguides; and
a plurality of signal manipulation elements comprising (a) a first set of signal manipulation elements of a first type and (b) a second set of signal manipulation elements of a second type, wherein a second signal manipulation element of the second set of signal manipulation elements is optically coupled to a waveguide of the plurality of waveguides via a first signal manipulation element of the first set of signal manipulation elements.

2. The signal management system of claim 1, wherein the signal manipulation elements of the first type are configured to couple respective photonic signals out of respective waveguides of the plurality of waveguides.

3. The signal management system of claim 1, wherein the signal manipulation elements of the second type are configured to redirect the respective photonic signals to respective target positions of the plurality of target positions.

4. The signal management system of claim 1, wherein the signal manipulation elements of the first type are grating couplers.

5. The signal management system of claim 1, wherein the signal manipulation elements of the second type are metasurfaces.

6. The signal management system of claim 1, wherein an optical path defined by a waveguide of the plurality of waveguides, a signal manipulation element of the first type, and a signal manipulation element of the second type is an optical path defined in three-dimensional space.

7. The signal management system of claim 1, wherein a waveguide and signal manipulation element defining a portion of an optical path are fabricated and measurement information regarding the function thereof are obtained and a signal manipulation element defining a further portion of the optical path is designed based on the measurement information.

8. The signal management system of claim 1, wherein the signal manipulation elements of the second type are configured to control one or more optical properties of a respective photonic signal provided to a respective target location, the one or more optical properties including at least one of direction of propagation, wavelength, polarization, relative phase delay, optical mode, or focal location.

9. The signal management system of claim 1, wherein at least one optical path defined by the signal management system includes at least two signal manipulation elements of the second type that are flood illuminated by a signal manipulation element of the first type such that the at least two signal manipulation elements of the second type concentrate the optical power incident thereon to provide respective photonic signals to respective target locations.

10. The signal management system of claim 1, wherein at least one:
at least one of the signal manipulation elements of the second type functions as a beam splitter, or
at least one of the signal manipulation elements of the second type functions as a beam combiner.

11. The signal management system of claim 1, wherein at least one signal manipulation element of the plurality of signal manipulation elements is used as a signal manipulation element of a first type for a first photonic signal and as a signal manipulation element of a second type for a second photonic signal.

12. The signal management system of claim 11, wherein the first photonic signal is characterized by a first wavelength, the second photonic signal is characterized by a second wavelength, and the first wavelength is shorter than the second wavelength.

13. A confinement assembly comprising:
a confinement apparatus configured to confine a plurality of quantum objects; and
a signal management system configured to provide photonic signals to a plurality of target positions defined at least in part by the confinement apparatus, the signal management system comprising:
a plurality of waveguides, and
a plurality of signal manipulation elements comprising (a) a first set of signal manipulation elements of a first type and (b) a second set of signal manipulation elements of a second type, wherein a second signal manipulation element of the second set of signal manipulation elements is optically coupled to a waveguide of the plurality of waveguides via a first signal manipulation element of the first set of signal manipulation elements.

14. The confinement assembly of claim 13, wherein the confinement apparatus is hosted on a first substrate and at least one of:
at least one waveguide of the plurality of waveguides and at least one signal manipulation element of the plurality of signal manipulation elements is formed on or in the first substrate; or
the confinement assembly comprises a second substrate that is secured with respect to the first substrate and at least one waveguide of the plurality of waveguides and at least one signal manipulation element of the plurality of signal manipulation elements is formed on or in the second substrate.

15. The confinement assembly of claim 14, wherein an object-facing surface of the first substrate or the second substrate is used to spatially filter optical signals emitted therethrough using total internal reflection.

16. The confinement assembly of claim 14, wherein a filter layer is disposed on an object-facing surface of at least one of the first substrate and the second substrate and the filter layer is configured to spatially filter optical signals emitted therethrough.

17. The confinement assembly of claim 16, wherein the filter layer comprises a plurality of windows with each window corresponding to a respective target location.

18. The confinement assembly of claim 17, wherein the filter layer is optically opaque and the plurality of windows are optically translucent.

19. An atomic and/or quantum system comprising:
a confinement assembly comprising:
a confinement apparatus configured to confine a plurality of quantum objects; and
a signal management system configured to provide photonic signals to a plurality of target positions defined at least in part by the confinement apparatus, the signal management system comprising:
a plurality of waveguides, and
a plurality of signal manipulation elements comprising (a) a first set of signal manipulation elements of a first type and (b) a second set of signal manipulation elements of a second type, wherein a second signal manipulation element of the second set of signal manipulation elements is optically coupled to a waveguide of the plurality of waveguides via a first signal manipulation element of the first set of signal manipulation elements, and
at least one manipulation source configured to generate and provide photonic signals to at least one of the plurality of waveguides.

20. The atomic and/or quantum system of claim 19, wherein the system is an atomic qubit or quantum charge-coupled device (QCCD)-based quantum computer.
